(19) United States
(12) Patent Application Publication
(10) Pub. No.: US 2012/0326671 A1
(43) Pub. Date: Dec. 27, 2012

(54) BALANCING THE STATES OF CHARGE OF CHARGE ACCUMULATORS

(75) Inventor: Axel Krause, Nesslau (CH)

(73) Assignee: BRUSA ELEKTRONIK AG, Sennwald (CH)

(21) Appl. No.: 13/582,428

(22) PCT Filed: Feb. 28, 2011
(86) PCT No.: PCT/IB11/50848

§ 371 Date: Sep. 13, 2012

Related U.S. Application Data
(60) Provisional application No. 61/313,866, filed on Mar. 15, 2010.

(30) Foreign Application Priority Data
Mar. 15, 2010 (CH) 00361/10

(51) Int. Cl. H02J 7/00

(52) U.S. Cl. 320/126

(57) ABSTRACT

Electrical systems for balancing charging or loading of parallel-arrayed charge accumulators (1, 2), particularly batteries, storage batteries, etc. The systems include circuitry used to supply voltage to a load (7) or to electrically charge the accumulators (1, 2), or both, via connections (3a, 3b, 4a, 4b) at the charge accumulator side and interface connections at the load or charger side. An electrical circuit (10) has at least one DC converter (11) that converts the differential voltage between the matching polarity connections (3a, 4a) at the charge accumulator side, or converts a voltage derived from this differential voltage. Voltage supply devices for loads, or charging devices for charge accumulators, may include circuits of this type.

This application is a 35 U.S.C. 371 national-phase entry of PCT International application no. PCT/IB2011/050848 filed on Feb. 28, 2011 and also claims benefit of priority to Swiss national application no. CH-00361/2010 filed on Mar. 15, 2010, and also claims priority as a non-provisional of U.S. provisional application Ser. No. 61/313,866 filed on Mar. 15, 2010; parent application PCT/IB2011/050848, Swiss national application no. CH-00361/2010 and U.S. provisional application Ser. No. 61/313,866 are all incorporated herein by reference in their entireties for all intents and purposes, as if identically set forth in full herein.

The invention relates to an electrical circuit for a parallel array of at least two charge accumulators, particularly batteries, storage batteries, etc., for the voltage supply of a load and/or for the electrical charging of the charge accumulators, with connection terminals at the charge accumulator end and connection terminals at the load or charging ends and with at least one DC converter. The invention also relates to a voltage supply device for a load, which incorporates this type of circuit. The invention further relates to a charging device that incorporates this sort of circuit.

Technical advances mean that in the coming years it will be possible to develop electric vehicles offering attractive driving performance and to produce them in greater numbers. For the foreseeable future, the most expensive individual component of a vehicle of this type will be the battery. A vehicle manufacturer can optimise costs in this respect by using the same battery for all vehicle categories supplied. Small vehicles will only be fitted with one battery; larger vehicles with two or more. This will enable greater unit numbers to be achieved and the cost of testing and certifying the battery will only be incurred once for all vehicles.

A rated voltage of 300-400 V has proved optimal in cars and light-duty commercial vehicles. It stands to reason, therefore, that the battery should be designed with this rated voltage and in larger vehicles several such batteries should be connected in parallel. In this way, the voltage remains the same and only the capacity is multiplied according to the number of batteries. Tests have revealed that there is not always an even distribution of load for two or more batteries connected in parallel. Particularly where batteries have different thermal conditions, their capacities and currents may diverge. The current voltages or states of charge of the individual batteries alter irregularly as a result. The different loads applied to the batteries may lead to premature ageing and thereby compromise the vehicle's reliability. Similar problems occur when charging the batteries. This may lead to individual batteries being charged unevenly or even being overcharged, which causes the life of the battery to be significantly reduced.

There are state-of-the-art circuits for various battery arrays, which are designed to increase the life of batteries or prevent them from being destroyed. The known solutions will be examined more closely below; most of them relate to a circuit for balancing the different voltages or states of charge of the batteries concerned.

U.S. Pat. No. 6,353,304B1 discloses a system for charging and discharging batteries connected in parallel. The charging involves using an AC generator and an AC-DC converter. In a first phase, both batteries A, B are connected straight to the AC-DC converter and uniformly charged. Even before the two batteries are fully charged, the system switches to phase two.

This involves one of the batteries B being connected to the load, while the other battery A is simultaneously connected to the battery B via the DC-DC converter. Battery A is now fully charged by battery B via a step-up device. Battery B is discharged as a result. It is only when battery A is fully charged that it is connected to the load alongside battery B (phase 3). The same occurs in the following charging cycle, except that rather than battery A, battery B is now fully charged. This system should, in particular, increase the life of the batteries.

However, this reference does not envisage any measures for preventing or balancing a differing degree of load applied to the batteries in phase 3, which means that there is no optimum working load. The DC-DC converter also always processes the entire battery voltage in phase 2 and must be of correspondingly large dimensions.

AT 505169 B1 discloses a redox flow battery with two parallel-connected functional units. Each functional unit may be disconnected by a switch. In addition, a device, e.g. a DC-DC converter, is provided, in order to connect a disconnected functional unit, e.g. a battery, to the still active sub-system (another battery). With the DC-DC converter, the residual energy of the disconnected battery may be used to charge the other, still active battery. In this way, the self-discharge of the disconnected battery along with the negative side-effects can be prevented. This reference contains no teaching in relation to the problem of balanced utilization with simultaneous connection to the load.

U.S. Pat. No. 6,774,606B1 relates to the voltage supply, particularly in the case of satellites, and shows an array of batteries connected in parallel, which each form individual strings. The strings are each connected to a charge balancing unit. This reference actually relates to the parallel connection of individual batteries of different strings. No details are disclosed on the inner life of the charge balancing unit.

The following references are further removed from the invention, as they relate to series-connected batteries.

U.S. Pat. No. 5,479,083A discloses a charging device for multiple batteries. In a basic circuit, an inductor branches off between two series-connected batteries. Two switches alternately operated by an oscillator (e.g. at a frequency of 200 kHz and with a 50% frequency ratio) ensure that the batteries are evenly charged. In this case, the inductor should prevent power losses as a non-dissipative shunt. The flow through the inductor undergoes a complete reversal when the switches are changed, at least when the batteries are almost identically charged, which means on the one hand that throttles of the appropriate size are required and, on the other, relatively high losses occur.

U.S. Pat. No. 5,631,534A discloses a battery balancer in the form of a current pump module, which displays great similarities to the previous reference. In order to transfer charge from the first to the second battery, a first switch is operated by means of a PWM signal, while the second switch is left open. When the first switch is closed, the current in the inductor increases, when the first switch is open, it supplies the second battery via the second diode. The whole process also operates in the same way in reverse.

U.S. Pat. No. 7,049,791 B2 discloses a battery balancer circuit for the uniform charging of multiple series-connected batteries. The switches, e.g. MOSFETs, are operated alternately, so that the state of charge of both batteries can be balanced via the charge bypasses with the inductors and capacitors and overcharging can be prevented.

US2009/0278489 discloses a system and a method that dynamically equalises battery voltages. As with the previous references, the batteries are series-connected in this case and the remaining features also strongly resemble the preceding references.

U.S. Pat. No. 6,150,795A also relates to the problem of battery charge equalisation and pursues in circuitry terms a similar or related basic principle as the previous reference. The batteries are once again series-connected.

In the case of the voltage supply of a load with a parallel battery pack, there are also circuits that counter the problems of uneven utilization described above by having the energy flow to and from each battery passing through its own bidirectional DC-DC converter. In other words, each individual battery is separated from the high-voltage BUS by a DC-DC-converter. In this case, all DC-DC converters are parallel-connected to the high voltage BUS at the output end. The voltage to the load may be freely selected in this case within the framework of the DC-DC operating range, irrespective of the battery voltages. However, the disadvantages are that the converters must be correspondingly powerful and therefore occupy a lot of space, because they each convert the entire battery voltage, that high power losses occur at the converters as a result of this and that the provision of its own DC-DC converter for each individual battery requires a high level of expenditure. All these requirements have a negative impact on the weight, space requirement and cost of this sort of circuit.

One of the goals of the invention is to create a circuit to balance out the state of charge of at least two batteries for a voltage supply device or a charging device, which is unencumbered by these disadvantages and in which the losses due to voltage conversion, in particular, are minimised and which is characterised by a simple design. Moreover, the weight, spatial requirement and cost of this sort of circuit should be significantly lower than the state of the art.

The invention achieves these goals and others with a circuit of the type mentioned above, in that the DC converter connects one of the connection terminals at the load or charge end to the corresponding matching connection terminals at the charge accumulator end, which are each assigned to matching terminals of the charge accumulator or combined charge accumulators, wherein corresponding terminals at the charge accumulator end can be connected by switches as active elements of the DC converter alternately or overlapping in time via at least one common passive element of the DC converter with the corresponding matching connection at the load or charging end.

This means that basically the highest differential voltage applied between matching connection terminals at the charge accumulator end or a voltage derived from this differential voltage is converted at most in the DC converter.

Where there are only two matching connection terminals at the charge accumulator end, the differential voltage applied between matching connection terminals at the charge accumulator end or a voltage derived from this differential voltage is essentially converted in the DC converter.

The invention relates to a method of balancing the states of charge of at least two parallel-connected charge accumulators, particularly batteries, storage batteries, etc, during the voltage supply of a load by the charge accumulator or during the charging of the charge accumulator, wherein at least one DC converter is used, characterised in that with switches as active elements of the DC converter the matching terminals of the charge accumulators are applied alternately with the combined matching connection terminal of the charge accumulator chain formed from the at least two charge accumulators.

The new approach is based on the consideration that the voltage difference of the two batteries is usually very small and amounts to only a few percent of a battery's total voltage. This means that it is advantageous to use a converter in such a way that only this differential voltage occurs as the converter's “operating voltage”. This means that the power processed in the converter is significantly smaller than in the circuits described above, even if the converter has to process the full battery current.

The balancing of the state of charge of the batteries therefore takes place during the voltage supply of a load or during the charging of the charge accumulator. The circuit according to the invention switches alternately from one battery to the other, so that in a first switch state the battery voltage of the first battery at the converter becomes effective and in a second switch state the battery voltage of the second battery at the converter becomes effective. The DC proportions remain unaffected by the converter's mode of operation and are allowed through unchanged and applied to the output (hereafter referred to as “load-side connection terminals” in the case of a voltage supply and “charge-side connection terminals” in the case of a charging device). Only voltage changes caused by the alternately operated switches, which only occur on the scale of the voltage difference between the batteries, are changed in the converter.

A DC converter comprises active elements—switches, also referred to as choppers—which generate a time-periodic voltage curve from a DC voltage (they “chop” the voltage in a particular period) and passive elements, which again generate a DC voltage from the voltage curve changing in time. This is a sort of low-pass filter or smoothing circuit. In other words, only that part of the voltage that changes in time is converted, whereas the DC voltage part that is constant in time passes the converter unimpeded. The latter portion only causes ohmic losses, while the ripple voltage results in power losses, particularly due to the constant current change in the throttle. In the present case, the DC-DC converter does not therefore convert the total voltage of the individual batteries, but only their differential voltage. This means that it can be executed as a significantly smaller, more cost-effective design. Since it is essentially only the differential voltage or a voltage diverted from this that is converted, the power losses in the converter also remain small.

The notion of “voltage derived from the differential voltage” relates to variants that are doubtless conceivable but are less preferred, in which voltage dividers and/or other converter stages are interposed, because this would lead to additional losses in these elements. Where there are three or more batteries, the differential voltage of each battery compared with the load voltage is crucial; this means that there are several differential voltages, e.g. in the case of n batteries connected to the negative terminal, n*(n−1)/2 differential voltages can be measured between the positive terminals.

In the following, the circuit is described in relation to a voltage supply for a load. The aim here is for the batteries that contribute to the voltage supply to be loaded depending on their respective states of charge. The battery with the higher voltage receives a correspondingly greater load than the battery with the lower voltage. It is of course conceivable, however, that the same principle will also apply to a charging device that charges two or more charge accumulators. Conversely, the aim here is for the batteries to be charged evenly and for the charge current—likewise depending on the state of charge of the individual batteries—to be divided proportionately between the individual charge accumulators. In principle, the same circuit may, for example, be integrated in an electric vehicle, used both as a voltage supply and also for charging.

The term “connection terminal” not only refers to a physical connection within the meaning of a reciprocal plug connection or the like, but also covers, apart from the meaning as defined by connection, the meanings of input, output, terminal, line, connection, etc.

The invention is explained in greater detail below by means of the drawings. In these:

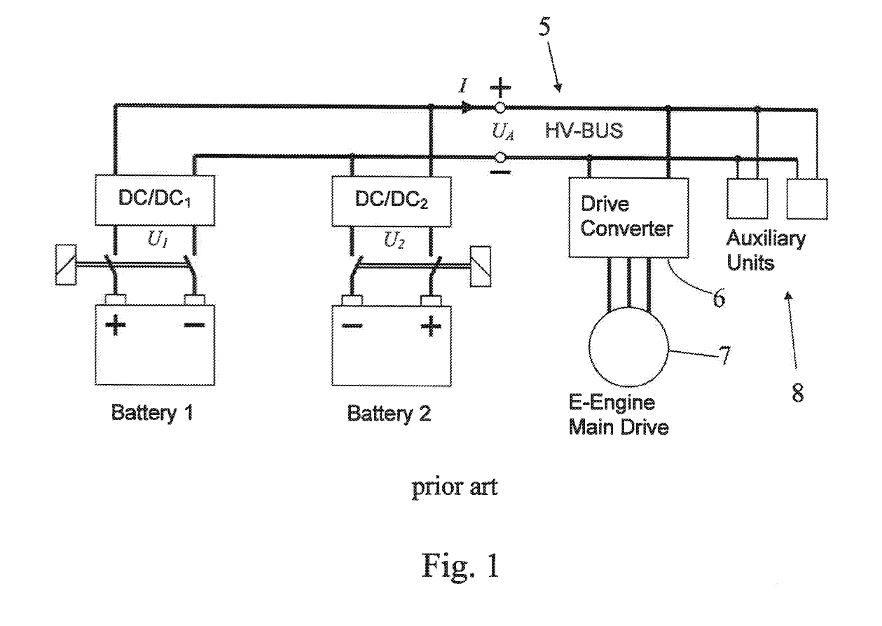

FIG. 1 shows a circuit with symmetrical topology for a voltage supply according to the state of the art,

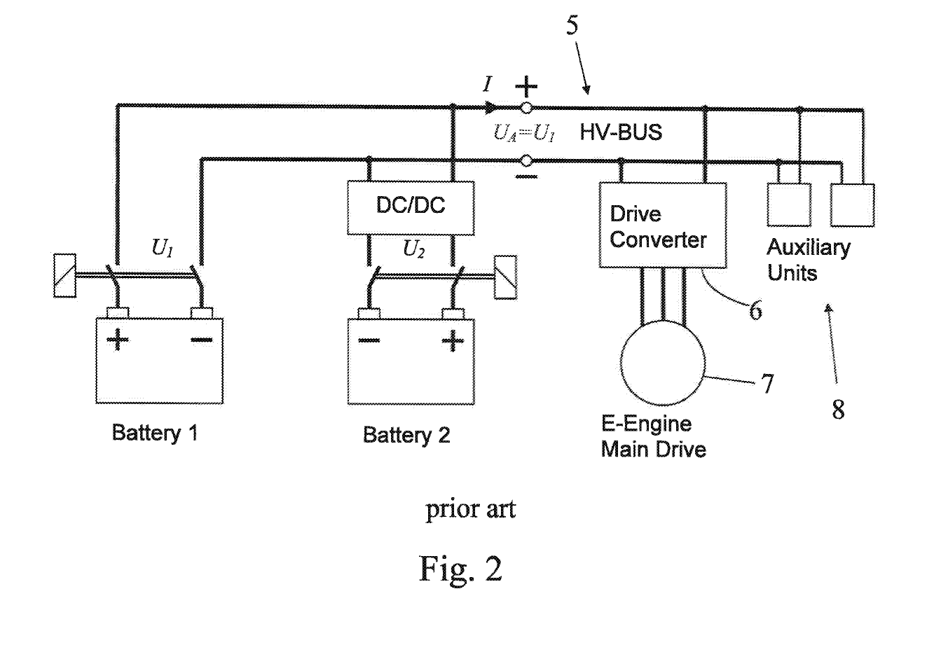

FIG. 2 shows a circuit with asymmetrical topology for a voltage supply according to the state of the art,

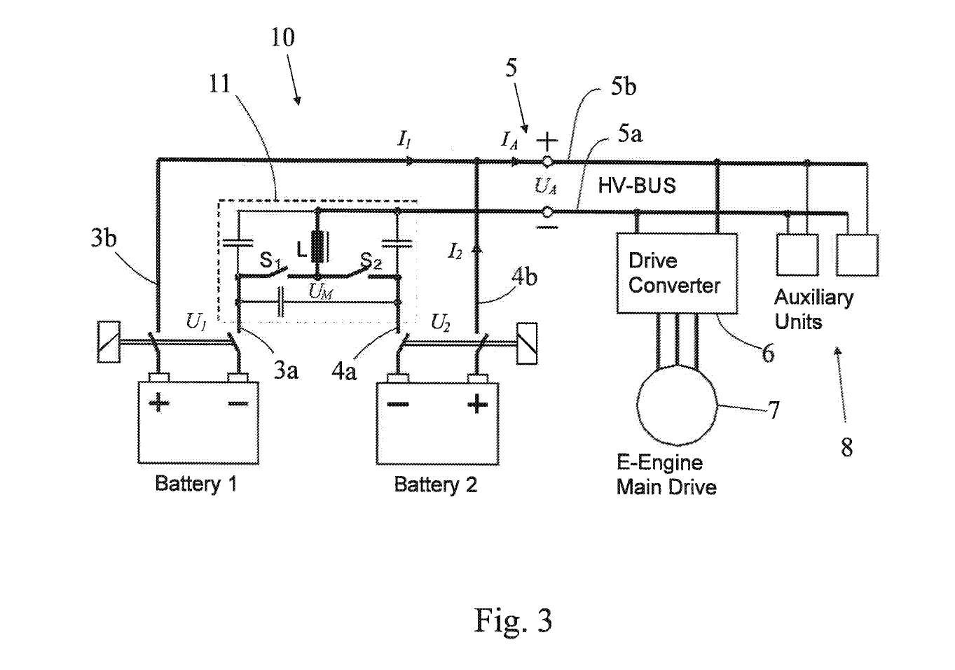

FIG. 3 shows a circuit according to the invention,

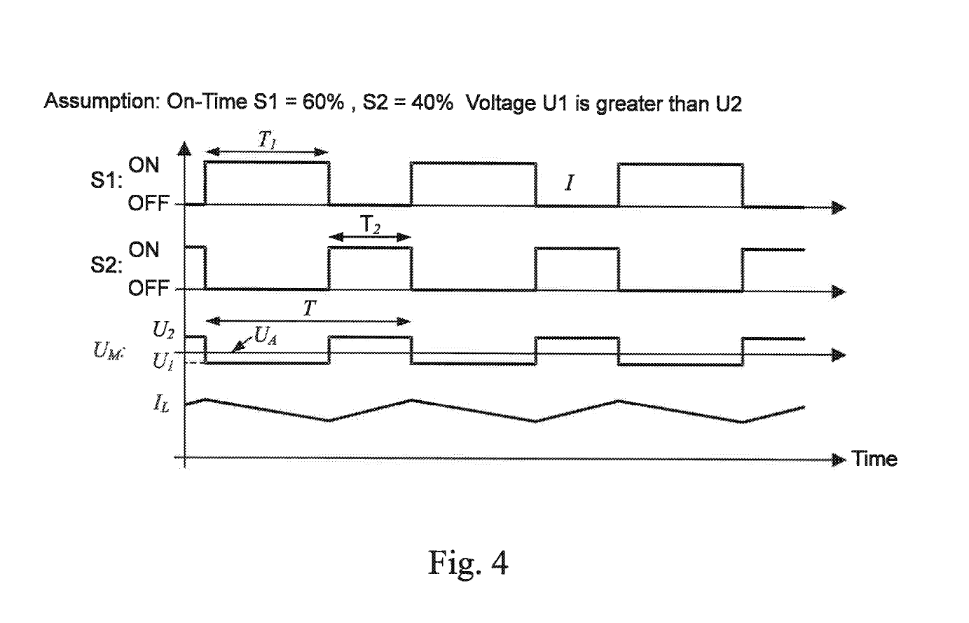

FIG. 4 shows switch states, voltages and currents in a circuit according to FIG. 3 as a function of time,

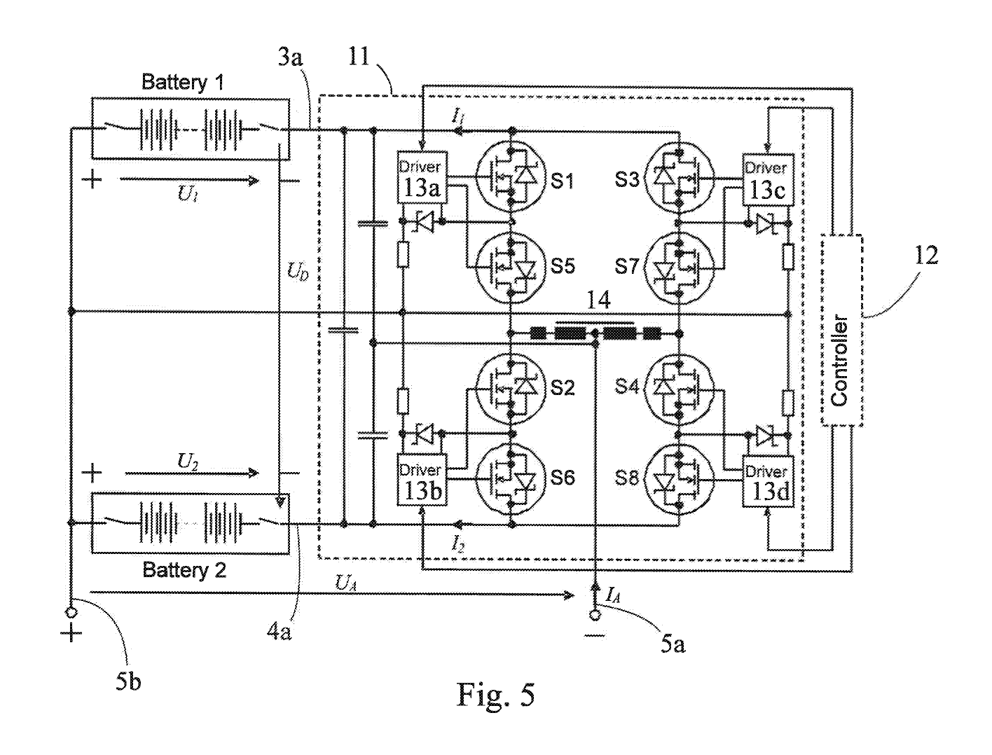

FIG. 5 shows a version of a circuit according to the invention with a transformer-connected double throttle,

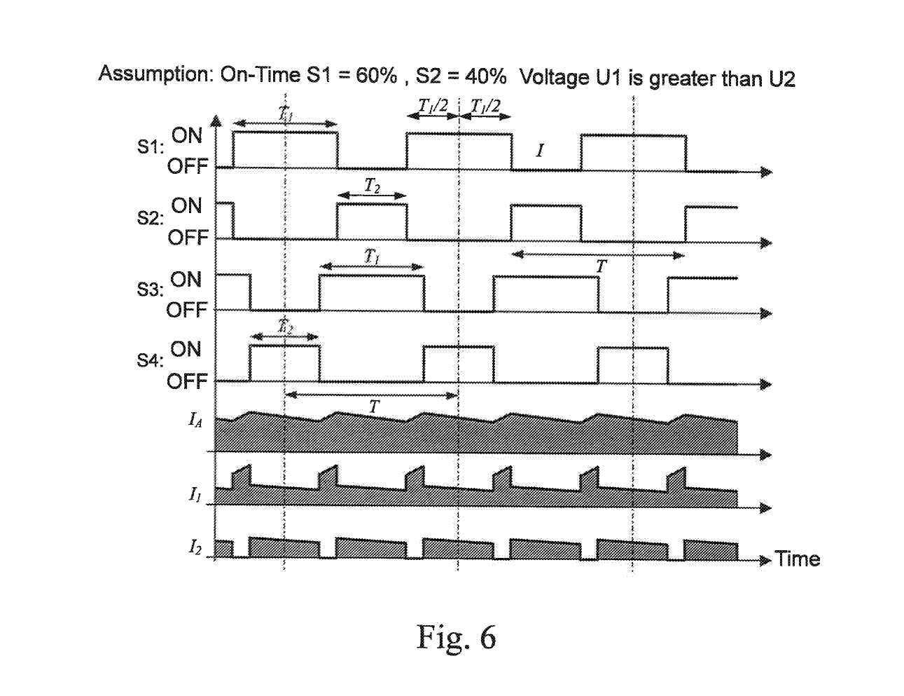

FIG. 6 shows switch states and currents in a circuit according to FIG. 5 as a function of time,

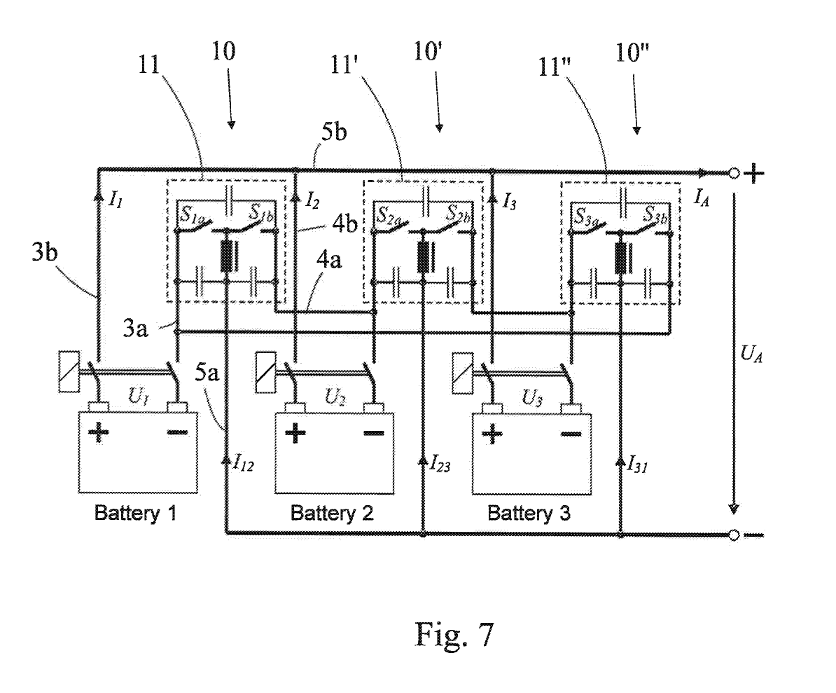

FIG. 7 shows a circuit according to the invention with three batteries,

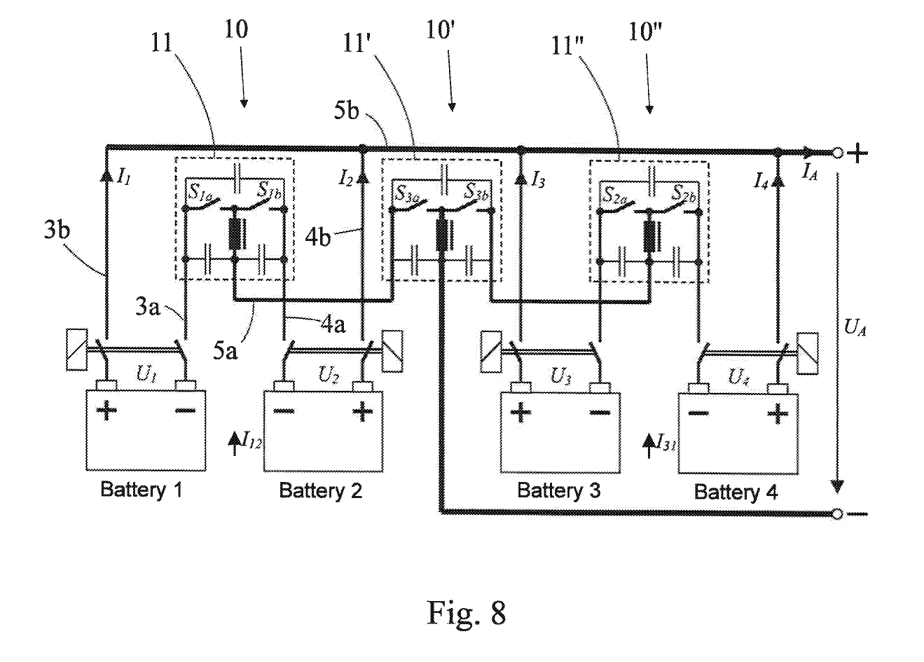

FIG. 8 shows a circuit according to the invention with four batteries,

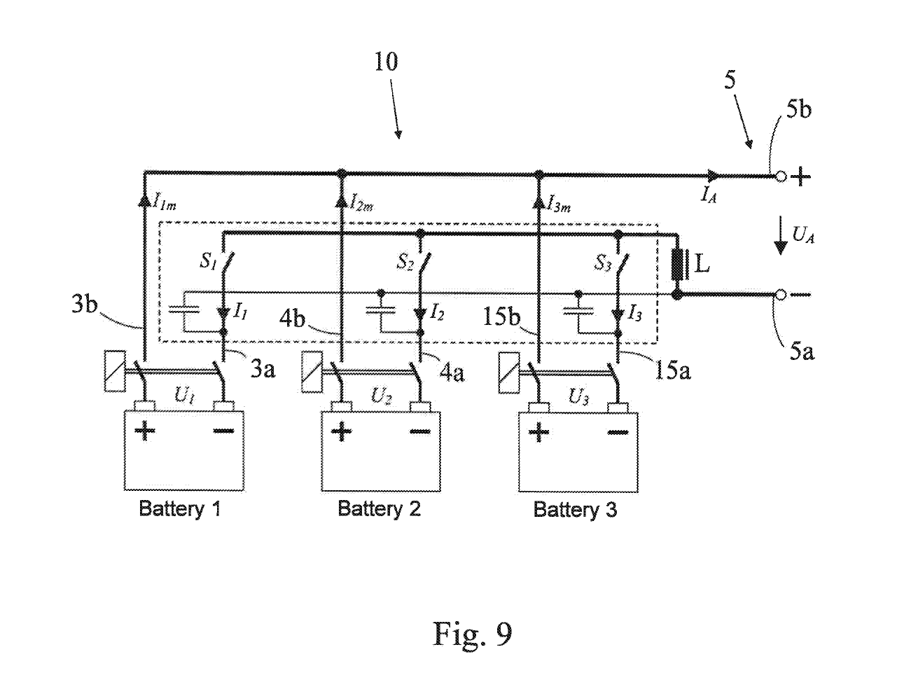

FIG. 9 shows a variant of a circuit according to the invention with three batteries,

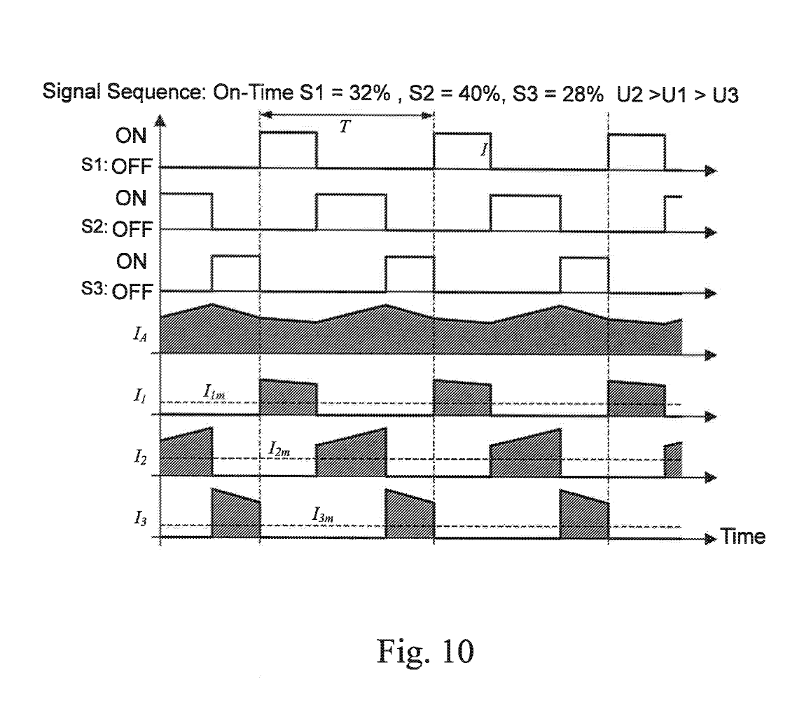

FIG. 10 shows switch states and currents of a circuit according to the invention in accordance with FIG. 9 as a function of time.

FIG. 1 shows the circuit known from the state of the art and already mentioned above, in which the energy flow to and from each battery 1, 2 goes via its own bidirectional DC-DC converter. For this reason, this circuit is also referred to as symmetrical topology. All DC-DC converters are parallel-connected at the output end to the high-voltage BUS 5. The voltage to the load 7 may be freely selected within the framework of the DC-DC operating range, irrespective of the battery voltages. The contributions made by each individual battery to the total current I may be set independently of one another in this case. The DC-DC converter may take the form of a step-up converter, a step-down converter or a step-up/step-down converter. As already mentioned above, this sort of circuit is associated with high expenditure and high costs, since each battery requires its own DC-DC converter.

On the basis of FIG. 1, FIG. 2 shows an asymmetrical topology in which the first battery is connected directly to the HV-BUS 5. The energy flow to and from each additional battery goes via its own bidirectional DC-DC converter. All DC-DC converters are parallel-connected to the high-voltage BUS 5 at the output end. What is advantageous compared with the previously described variant from FIG. 1 is the fact that a DC-DC converter is less necessary. However, the BUS voltage is no longer freely selectable and the DC-DC converters must take the shape of costly step-up/step-down converters.

The principle disadvantage of the circuits shown in FIG. 1 and FIG. 2 is that the total power of the battery connected in each case must be processed in each DC-DC converter. In a vehicle with a drive power of 100 kW, the converted power is at least 50 kW. This sort of converter requires a considerable installation space (at least 5 litres) and represents a heavy additional component (at least 10 kg) in weight terms. In addition, there are unavoidable losses of at least 2% of processed power, i.e. the vehicle's range drops correspondingly.

FIG. 3 shows a circuit 10 according to the invention for balancing the states of charge of the accumulators 1, 2 in case of the supply of a load 7. Two parallel-connected charge accumulators 1, 2, e.g. batteries, storage batteries, etc. are applied to a high-voltage bus 5 from two terminals 5a, 5b via the circuit 10. In the present exemplary embodiment, a drive converter 6 ensures preparation of the voltage for an engine. Moreover, auxiliary units 8 can be connected.

The heart of the circuit 10 is a DC converter 11, also referred to as a DC-DC converter or chopper. It has two connection terminals 3a, 4a at the charge accumulator end, which are respectively connected to matching polarity terminals (in the present case, negative terminals) on the charge accumulators 1, 2, and also one connection terminal 5a at the high-voltage bus 5 end, hereinafter referred to as the load end.

The opposing terminals, in relation to polarity, on the charge accumulators 1, 2 (the positive terminals in the present case) are connected to the connection terminals 3b and 4b in the circuit 10. The connection terminals 3b and 4b are connected straight to the other terminal 5b for the HV bus 5.

So whereas the connections 3b, 4b with the same polarity are connected straight to the HV-bus 5, connections 3a, 4a with opposing polarity are connected to the HV-bus 5 through the insertion of a DC converter 11.

Each DC converter is essentially made up of active elements, which modulate an input voltage, and passive elements, which generate a DC voltage as the output voltage from the modulated voltage. The aim here is for the output voltage to have a different value to the input voltage. As can be seen from FIG. 3, the DC converter 11 is made up of two switches S1, S2 as the active elements and also a throttle L as the passive element. Moreover, parallel-connected capacitors are also provided as passive elements.

The switches S1, S2 are operated across a controller (not shown in FIG. 3) and connect alternately the two matching terminals of the charge accumulators 1, 2 with the corresponding matching connection terminal 5a of the high-voltage BUS 5. In other words, the switches S1, S2 operated alternately each switch between the matching terminals of the two charge accumulators 1, 2 and the connection terminal 5a at the load end. If one switch is connected through, the other is open and vice versa. The switching states are therefore connected up directly (i.e. without gaps), so that one of the charge accumulators is always connected to the passive element L of the DC converter 11. As can be seen from the exemplary embodiment in FIG. 3, the matching battery terminals (in this case negative terminals) are connected exclusively to the HV BUS 5 via the DC converter 11. There are therefore no bypasses to shunt over the DC converter 11.

FIG. 4 illustrates the switching states of the switches S1, S2 over the course of time and also the corresponding voltages and currents occurring. In this case, U₁ denotes the voltage of the first battery 1 and U₂ the voltage of the second battery. It is assumed in this case that U₂ is greater than U₂. U_{M} is the differential voltage U₁-U₂, which is actually processed in the DC converter 11. U_{A} is the smoothed output voltage to the load-end terminals 5a, 5b in the circuit 10. T₁ and T₂ each denote the on-times of the switches S1 and S2. I_{L} is the load current generated at the output.

It is expressly pointed out that the switches S1 and S2 are an integral or functional element of the DC-DC converter and, as its active elements, bring about modulation of the voltage, which is processed in the following passive elements of the converter and then applied to the outgoing terminal 5a. The bipolar switches can be operated by a controller and designed to switch at frequencies of 20 to 500 kHz, preferably roughly 50 kHz to 150 kHz. The switches S1 and S2 are preferably executed using low-voltage MOSFETS, which give rise to very low losses, even when there is a high current (R_{DS(on)}≈1 mΩ). In terms of the principle, however, any type of switch can be used—MOSFETs, transistors (e.g. IGBTs), thyristors, etc.

As can be seen from FIG. 4 by means of the voltage curve, only the “differential power” P_{Diff}=(U₁−U₂)·I need be processed in the DC converter. This represents a crucial advantage compared with state-of-the-art circuits, in which a battery's total voltage must always be converted. The throttle in the invention can therefore be of far smaller dimensions, since only the differential voltage U₁-U₂ occurs there as a ripple voltage. A circuit according to the invention may therefore be small, light and compact in design, which means that the dimensions are essentially determined only by cable connections.

Two operating modes are possible with the circuit according to the invention:

Both switches S₁, S₂ are switched through. This mode is characterised by the expression “overlapping in time”, which has already been used above. Only ohmic losses occur in this case.

S₁, S₂ synchronise alternately at a given frequency, e.g. a frequency between 50 kHz . . . 150 kHz. In this case, the pulse width modulation or frequency ratio determines the current division I₁/I₂ or the ratio of the individual currents I₁ and I₂ to the total current I_{A}.

It should be noted in this case that the switches must be able to interrupt the current flow in both directions and that the voltage across the switches must not be allowed to exceed the permitted inverse voltage (e.g. rated at 10-20% of the battery's rated voltage). In case of emergency, the switches must be connected through or the battery disconnected by means of the contactors.

In the synopsis with FIG. 4, the proportionate contributions of the individual voltages and currents to the total voltage and total current are joined together. This produces the following relationship, as is known from the customary step-down converters:

The voltage U_{A} is the total of the two battery voltages U₁ and U₂ weighted with the relative voltage application duration in each case (pulse width or pulse-duty factor); where

$$T = {T}_{1} + {T}_{2} , {U}_{A} = \frac{{T}_{1} \cdot {U}_{1} + {T}_{2} \cdot {U}_{2}}{T}$$

The current I_{A} is divided proportionately between the two batteries in relation to the voltage application times in each case:

$${I}_{A} = \frac{{T}_{1} \cdot {I}_{1} + {T}_{2} \cdot {I}_{2}}{T} {I}_{1} = \frac{{T}_{1}}{T} \cdot {I}_{A} {I}_{2} = \frac{{T}_{2}}{T} \cdot {I}_{A}$$

Consequently, the current distribution between the batteries may be selected at random by choosing the voltage application times T₁ and T₂.

The circuit's optimum frequency ratio is preferably regulated by the fact that the controller receives feedback on the current state of charge of the individual batteries. This may result, for example, from the voltage and/or current from the individual batteries being measured continuously or at given intervals in time and the corresponding measurement passed on to the controller.

FIG. 5 shows, for example, a specific embodiment of the invention with a transformer-connected double throttle 14 and MOSFETs S1, S2, S3, S4, S5, S6, S7, S8 as switches, wherein two MOSFETs in each case together form a bipolar switch. Controller 12 is also illustrated for the DC converter 11, which is connected to the drivers 13a, 13b, 13c, 13d via control lines. The drivers operate the switches assigned to them according to the control commands. Controller 12 and driver 13 create a pulse width modulation (PWM) device, through which the voltage existing between the terminals 3a, 4a at the accumulator end or a voltage diverted from this is (periodically) modulated. The differential voltage of the two batteries U₁-U₂ is designated U_{D}.

The advantages of this circuit are that a smaller throttle can be used and that a continuous, ripple-free current flow can be achieved in each battery at a 50% duty cycle, in other words, in the case of T₁=T₂=T/2. The connection to the battery's positive terminal is only used in this case to supply the drivers, for example (power requirement low watts) and has no function in the main circuit.

FIG. 6 depicts the temporal correlation of the switching states and currents in relation to the circuit from FIG. 5. It is assumed in this case that U₁>U₂, i.e. the differential voltage U_{D} is positive. The controller 12 then permanently switches through the MOSFETs S5 to S8 via the drivers 13a, 13b, 13c, 13d. The remaining MOSFETs S1 to S4 create two parallel half-bridges, which are each switched with a 180° phase-displaced, symmetrical pulse width modulation (PWM) in accordance with FIG. 6.

FIGS. 7 and 8 show that the invention is not restricted to circuits with two batteries, but is actually open-ended. FIG. 7 shows, for example, an array of three batteries 1, 2, 3, wherein any number of batteries can be switched using the same process. For n batteries, n balancer circuits 10 or DC converters 11 are needed according to this circuit n. In this case, a terminal of a charge accumulator 1, 2, 3 is simultaneously connected to two adjacent DC converters 11. In this case, each of the DC converters shown with a dotted outline may be designed, for example, according to the part with the dotted outline in FIG. 3 or FIG. 5. Starting with the required currents I₁, I₂, I₃, currents I₁₂, I₂₃ and I₃₁ result as follows:

I₁₂=T₁·I₁+(T−T₁)·I₂

I₂₃=T₂·I₂+(T−T₂)·I₃

I₃₁=T₃·I₃+(T−T₃)·I₁

When both switches are in a stationary, switched-through state, this is a special case of operation overlapping in time. The general (synchronised) overlapping operation is not of course preferred in all configurations. Particularly in the case of systems with more than one throttle (e.g. FIG. 7), this may, however, quite possibly be a preferred variant, e.g. if the total voltage application times of the switches connected to a battery terminal (e.g. S1a and S3b in FIG. 7) is greater than 100%.

FIG. 8 shows a possible design for the 2nd batteries. If the number n of batteries is an integral exponent of 2 (in other words, 2, 4, 8, 16, . . . a power of 2), n−1 string balancer circuits 10 are sufficient. Based on the example of a total of four batteries 1, 2, 3, 4, this shows how a string balancer is connected either to the negative terminals of 2 batteries or to the outputs of 2 string balancers in each case.

The embodiment shown in FIG. 8 comprises three circuits according to the invention 10, 10′, 10″ (only the first of which is shown in full), wherein the connection terminal 5a at the load or charging end of the circuit 10 is not connected straight to the HV BUS, but to the connection terminal at the charge accumulator end of an adjacent circuit 10′. The same applies to the circuit 10″.

The definition of “charge accumulator-end connection terminals” on the one hand and “load- or charging-end connection terminals” on the other hand is always arrived at from the point of view of the electrical circuit 10 in each case. In other words, those connection terminals that are closer to the charge accumulators or are assigned to these are referred to as being at the charge accumulator end. Those connection terminals that are closer to the load and/or the charging device or HV BUS are referred to as being at the load or charging end. Hence, it may quite easily be, as in FIG. 8, that a load- or charging end connection terminal 5a of a circuit 10 is not connected straight to the HV BUS, but via an intermediate circuit 10′.

As already mentioned earlier, the circuit according to the invention may also be an integral part of a charging device. The charge voltage is applied to the circuit's connection terminals at the charge end, e.g. via an AC/DC converter, and the charge current divided proportionately via the DC converter according to the pulse width modulation applied or the frequency ratio of the switches operated alternately. The current state of charge of the individual batteries is taken into account when controlling the switches, so that the frequency ratio can change in favour of a battery during the course of the charging process.

FIG. 9 shows yet another embodiment of a circuit 10 according to the invention. In this case, there is an alternating switch between three accumulators 1, 2, 3. In other words, the DC converter comprises three switches S1, S2, S3 as active elements, which alternately applies one of the three connection terminals 3a, 4a, 15a at the accumulator end via a common passive element L (throttle) to the matching connection terminal 5a at the load or charging end. In a similar way, more than three connection terminals and switches are also conceivable. FIG. 10 shows the corresponding switch states as a function of time.

Although the “modular approach”, as depicted in FIGS. 7 and 8, is impeded by this measure, as two switches in each case must always be bridged by a capacitor located as close as possible, with the variant in FIG. 9, only one throttle L is sufficient, which represents an advantage when there are only three batteries.

The three batteries illustrated in FIG. 9 are switched through in immediate succession, so that three voltage plateaux occur. In this case the differential voltage of two batteries is not processed, but at most the differential voltage between the battery with the highest voltage and the one with the lowest voltage.

In order to extend the corresponding wording to all embodiments shown, it should now be considered or established that in the circuit according to the invention it is essentially the greatest differential voltage applied between matching connection terminals at the charge accumulator end or a voltage derived from this differential voltage that is converted at best.

### REFERENCE LABELS LIST

1, 2, 3, 4 Charge accumulator
3a, 3b Connection terminals at the charge accumulator end
4a, 4b Connection terminals at the charge accumulator end
5 High voltage BUS
5a, 4b Connection terminals at the load or charging end
6 Drive converter
7 Load
8 Auxiliary units
10, 10′, 10″ Electrical circuits
11 DC converter
12 Controller
13a, 13b, 13c, 13d Driver
14 Transformer-connected double throttle
15a, 15b Connection terminals at the charge accumulator end
I₁,I₂,I₃,I₄ Charge accumulator currents
I_{L} Load current
L Passive DC converter element
S1, S2, S3, S4, S5, S6, S7, S8 Switches
U₁,U₂,U₃,U₄ Charge accumulator voltages
U_{A} Smoothed output voltage
U_{D} Differential voltage

What is claimed is:

1-11. (canceled)

12. A balancing circuit for parallel-connected charge accumulators, comprising:
a first charge accumulator;
a second charge accumulator;
a first DC converter, said DC converter having a first charge-accumulator end terminal, said first charge-accumulator end terminal being electrically connected to a first terminal of said first charge accumulator;
said first DC converter having a second charge-accumulator end terminal, said second charge-accumulator end terminal being electrically connected to a first terminal of said second charge accumulator, said first terminal of said second charge accumulator having the same polarity as said first terminal of said first charge accumulator;
said DC converter having a respective loading-or-charging interface connection terminal;
said DC converter having a respective common passive element; and,
said first DC converter including a first group of switches configured to controllably connect said first and second charge-accumulator end terminals to said interface connection terminal via said common passive element.

13. A balancing circuit for parallel-connected charge accumulators as claimed in claim 12, further comprising:
a first capacitor electrically connected between said first charge-accumulator end terminal and said loading-or-charging interface connection terminal, in parallel to said common passive element.

14. A balancing circuit for parallel-connected charge accumulators as claimed in claim 13, further comprising:
a second capacitor electrically connected between said second charge-accumulator end terminal and said loading-or-charging interface connection terminal, in parallel to said common passive element.

15. A balancing circuit for parallel-connected charge accumulators as claimed in claim 14, further comprising:
a third capacitor electrically connected between said first charge-accumulator end terminal and said second charge-accumulator end terminal.

16. The balancing circuit for parallel-connected charge accumulators as claimed in claim 12, wherein:
said common passive element is a throttle.

17. A balancing circuit for parallel-connected charge accumulators as claimed in claim 12, further comprising:
a third charge accumulator;
a second DC converter having a respective first charge-accumulator end terminal, said second DC converter's first charge-accumulator end terminal being electrically connected to said first terminal of said second charge accumulator;
said second DC converter having a respective second charge-accumulator end terminal, said second DC converter's second charge-accumulator end terminal being electrically connected to a first terminal of said third charge accumulator, said first terminal of said third charge accumulator having the same polarity as said first terminal of said second charge accumulator;
a third DC converter having a respective first charge-accumulator end terminal, said third DC converter's first charge-accumulator end terminal being electrically connected to said first terminal of said third charge accumulator; and,
said third DC converter having a respective second charge-accumulator end terminal, said third DC converter's second charge-accumulator end terminal being electrically connected to said first terminal of said first charge accumulator, said first terminal of said third charge accumulator having the same polarity as said first terminal of said first charge accumulator.

18. A balancing circuit for parallel-connected charge accumulators as claimed in claim 17, further comprising:
said second DC converter having a respective loading-or-charging interface connection terminal;
said third DC converter having a respective loading-or-charging interface connection terminal; and,
all of said loading-or-charging interface connection terminals are electrically connected.

19. A balancing circuit for parallel-connected charge accumulators as claimed in claim 18, further comprising:
said second DC converter having a respective common passive element;
said third DC converter having a respective common passive element;
said second DC converter including a second group of switches configured to controllably connect its respective first and second charge-accumulator end terminals to its respective interface connection terminal via its respective common passive element; and,
said third DC converter including a third group of switches configured to controllably connect its respective first and second charge-accumulator end terminals to its respective interface connection terminal via its respective common passive element.

20. The balancing circuit for parallel-connected charge accumulators as claimed in claim 19, wherein:
said common passive elements are throttles.

21. A balancing circuit for parallel-connected charge accumulators as claimed in claim 12, further comprising:
a third charge accumulator;
a fourth charge accumulator;
a second DC converter, said second DC converter having a respective first charge-accumulator end terminal, said second DC converter's first charge-accumulator end terminal being electrically connected to a first terminal of said third charge accumulator;
said second DC converter having a respective second charge-accumulator end terminal, said second DC converter's second charge-accumulator end terminal being electrically connected to a first terminal of said fourth charge accumulator, said first terminal of said fourth charge accumulator having the same polarity as said first terminal of said third charge accumulator;
said second DC converter having a respective loading-or-charging interface connection terminal;
said second DC converter having a respective common passive element; and,
said second DC converter including a second group of switches configured to controllably connect its respective first and second charge-accumulator end terminals to its respective interface connection terminal via its respective common passive element.

22. A balancing circuit for parallel-connected charge accumulators as claimed in claim 21, further comprising:
a third DC converter, said third DC converter having a respective first charge-accumulator end terminal, said third DC converter's first charge-accumulator end terminal being electrically connected to said first DC converter's respective loading-or-charging interface connection terminal;
said third DC converter having a respective second charge-accumulator end terminal, said third DC converter's second charge-accumulator end terminal being electrically connected to said second DC converter's respective loading-or-charging interface connection terminal;
said third DC converter having a respective loading-or-charging interface connection terminal;
said third DC converter having a respective common passive element; and,
said third DC converter including a third group of switches configured to controllably connect its respective first and second charge-accumulator end terminals to its respective interface connection terminal via its respective common passive element.

23. The balancing circuit for parallel-connected charge accumulators as claimed in claim 22, wherein:
said common passive elements are throttles.

24. A balancing circuit for parallel-connected charge accumulators as claimed in claim 12, further comprising:
a third charge accumulator;
said DC converter having a third charge-accumulator end terminal, said third charge-accumulator end terminal being electrically connected to a first terminal of said third charge accumulator, said first terminal of said third charge accumulator having the same polarity as said first terminal of said first charge accumulator and said first terminal of said second charge accumulator; and,
said first group of switches controllably connect said third charge-accumulator end terminal to said interface connection terminal via said common passive element.

25. The balancing circuit for parallel-connected charge accumulators as claimed in claim 24, wherein:
said common passive element is a throttle.

26. A balancing circuit for parallel-connected charge accumulators as claimed in claim 24, further comprising:
a first capacitor electrically connected between said first charge-accumulator end terminal and said loading-or-charging interface connection terminal, in parallel to said common passive element;
a second capacitor electrically connected between said second charge-accumulator end terminal and said loading-or-charging interface connection terminal, in parallel to said common passive element; and,
a third capacitor electrically connected between said third charge-accumulator end terminal and said loading-or-charging interface connection terminal, in parallel to said common passive element.

27. The balancing circuit for parallel-connected charge accumulators as claimed in claim 12, wherein:
said common passive element is a transformer-connected double throttle.

28. The balancing circuit for parallel-connected charge accumulators as claimed in claim 12, wherein:
said switches are MOSFETs.

29. The balancing circuit for parallel-connected charge accumulators as claimed in claim 28, wherein:
said MOSFETs have an operational frequency between 20 kHz and 500 kHz.

30. A method for balancing the states of charge of parallel-connected batteries, comprising:
electrically connecting a DC converter to corresponding-polarity terminals of a plurality of batteries; and,
selectively controlling switches in the DC converter to control the conversion of the highest differential voltage between the corresponding-polarity terminals of the plurality of batteries.

31. A method for balancing the states of charge of parallel-connected batteries as claimed in claim 30, further comprising:
selectively connecting the switches in series with a throttle.
